(19) United States
(12) Patent Application Publication
(10) Pub. No.: US 2023/0401257 A1
(43) Pub. Date: Dec. 14, 2023

(54) NON-TRANSITORY COMPUTER READABLE STORAGE MEDIUM AND ARTIFICIAL INTELLIGENCE INFERENCE SYSTEM AND METHOD

(71) Applicant: ADLINK TECHNOLOGY INC., Taoyuan City (TW)

(72) Inventors: Chung-Chih HUNG, Taoyuan City (TW); Chien-Chung LIN, Taoyuan City (TW); Ming-Chang KAO, Taoyuan City (TW)

(73) Assignee: ADLINK TECHNOLOGY INC., Taoyuan City (TW)

(21) Appl. No.: 17/884,255

(22) Filed: Aug. 9, 2022

(30) Foreign Application Priority Data
Jun. 8, 2022 (TW) 111121161

(51) Int. Cl. G06F 16/75; G06F 16/73; G06N 5/02

(52) U.S. Cl. CPC G06F 16/75; G06F 16/73; G06N 5/02

(57) ABSTRACT

A non-transitory computer readable storage medium storing a data structure and a computer program includes: a number of stored files each of which includes a number of fields including: at least one first field and at least one second field. Said at least one first field stores tag data of a region of interest of a video file, and said at least one second field stores inference data associated with the region of interest of a video file. The computer program reads the stored files and outputs a field content of the fields of the stored files when executed by a data processing device. The present disclosure also provides an artificial intelligence inference method and system configured to perform: searching the data structure according to a query to obtain a field content, and performing analysis according to input data and the field content.

### CROSS-REFERENCE TO RELATED APPLICATIONS

This non-provisional application claims priority under 35 U.S.C. § 119(a) on Patent Application No(s). 111121161 filed in Republic of China (ROC) on Jun. 8, 2022, the entire contents of which are hereby incorporated by reference.

### BACKGROUND

### 1. Technical Field

This disclosure relates to a non-transitory computer readable storage medium and artificial intelligence inference system and method.

### 2. Related Art

In the existing technology for image analysis using artificial intelligence, in addition to using post-processing nodes to perform image processing, logical analysis, etc. on the acquired images, the existing technology also includes the use of artificial intelligence inference nodes (eg, machine learning, deep learning). Since a single inference node can only perform a single type of image analysis, when there are several applications, several inference engines need to be connected in series. Further, since an inference engine following another inference engine needs to refer to the inferred result generated by said another inference engine, in a case where a large amount of inference engines are connected in series, the further the inference engine connected at the back, the more inferred results the inference engine will receive, and the inference engine is required to perform more logical operations. Accordingly, it would be difficult for users to select data they really need.

In addition, data format of each piece of inference data generated by each inference engine may be different, and the inference engines may have different logic requirements. Therefore, under this circumstance, the inference engine node can't be reused. When the logic requirements change, one or more inference engines need to be rewritten, which does not meet the needs of real environment.

### SUMMARY

Accordingly, this disclosure provides a non-transitory computer readable storage medium and artificial intelligence inference system and method which may meet the above requirements.

According to one or more embodiment of this disclosure, a non-transitory computer readable storage medium stores a data structure and a computer program, with the data structure includes: a number of stored files each of which includes a number of fields including: at least one first field and at least one second field. Said at least one first field stores tag data of a region of interest of a video file, and said at least one second field stores inference data associated with the region of interest of a video file. The computer program reads the stored files and outputs a field content of at least one of the fields of at least one of the stored files according to a query when executed by a data processing device.

According to one or more embodiment of this disclosure, an artificial intelligence inference system includes: a storage module and a processing module connected to the storage module. The storage module is configured to store a data structure, wherein the data structure includes: a number of stored files each of which includes a number of fields including: at least one first field and at least one second field. Said at least one first field stores tag data of a region of interest of a video file, and said at least one second field stores inference data associated with the region of interest of a video file. The processing module is configured to receive a query and input data, search the data structure according to the query to obtain a field content of at least one of the fields of at least one of the stored files, and perform analysis according to the input data and the field content to generate analysis data.

According to one or more embodiment of this disclosure, an artificial intelligence inference method is adapted to an artificial intelligence inference system including a storage module and a processing module, wherein the storage module stores a data structure, and the data structure includes: a number of stored files each of which includes a number of fields including: at least one first field and at least one second field. Said at least one first field stores tag data of a region of interest of a video file, and said at least one second field stores inference data associated with the region of interest of a video file. The artificial intelligence inference method, performed by the processing module, includes: receiving a query and input data; searching the data structure according to the query to obtain a field content of at least one of the fields of at least one of the stored files; and performing analysis according to the input data and the field content to generate analysis data.

In view of the above description, the data structure according to one or more embodiments of the present disclosure may store analysis data outputted by each artificial intelligence analysis node with unified data format, for different types of analysis data may be transmitted between artificial intelligence analysis nodes using different algorithms. Therefore, the overall analysis complexity and analysis time may be efficiently reduced, and thereby facilitating the integration and development of various analysis methods. In addition, the artificial intelligence inference system and method according to one or more embodiments of the present disclosure may be applied to a situation where a number of inference engines are connected in series as well as a situation where the inference engine and the logic node are connected in series, such that each of the inference engine may obtain data required for performing analysis, and may not need to confirm again whether the obtained data is the data required for performing the analysis. Therefore, the efficiency of the inference engine obtaining analysis data to be processed may be improved.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram illustrating one stored file of the data structure according to an embodiment of the present disclosure;

FIG. 2 is a block diagram illustrating an artificial intelligence inference system according to an embodiment of the present disclosure;

FIG. 3 is a flow chart illustrating an artificial intelligence inference method according to an embodiment of the present disclosure;

FIG. 4 is a flow chart illustrating an artificial intelligence inference method according to another embodiment of the present disclosure;

FIG. 5 is a flow chart illustrating an artificial intelligence inference method according to yet another embodiment of the present disclosure;

FIG. 6 is a flow chart illustrating an artificial intelligence inference method according to still another embodiment of the present disclosure;

FIG. 7A to FIG. 7E are schematic diagrams showing changes of a stored file of a data structure during the process of the artificial intelligence inference method of an embodiment of the present disclosure;

FIG. 8 is a schematic diagram illustrating a stored file of a data structure after performing the artificial intelligence inference method of an embodiment of the present disclosure; and

FIG. 9 illustrates an example of applying the artificial intelligence inference method and system on store entrance event analysis and advertising projection system.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

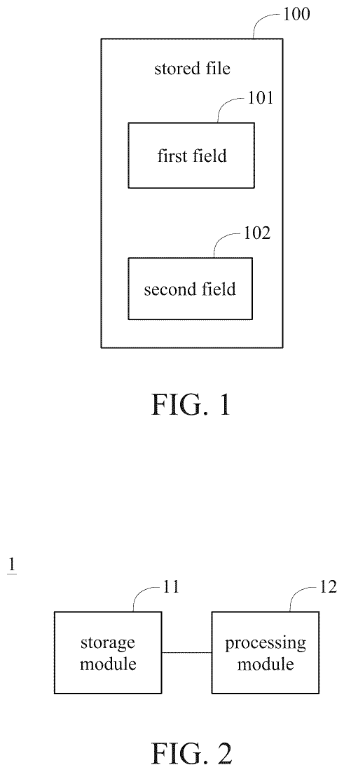

The present disclosure provides a data structure which includes a number of stored files, with each stored file including a number of fields, and the fields storing tag data and analysis data associated with a video file for a processing module to search and to output a corresponding field content according to a query. Please refer to FIG. 1, wherein FIG. 1 is a schematic diagram illustrating one stored file of the data structure according to an embodiment of the present disclosure. As shown in FIG. 1, each stored file 100 of the data structure includes a first field 101 and a second field 102, wherein the first field 101 is configured to store tag data of a region of interest (ROI) of a video file, and the second field 102 is configured to store inference data associated with the ROI. In addition, each stored file 100 may have a timestamp for indicating the fields 101 and 102 of the stored file 100 store data of the video file at said time stamp. Said data structure is searched by a processing module (for example, one or more processors) and the stored files 100 are read by the processing module, and a field content of at least one of the fields of at least one of the stored files 100 is outputted according to a query. In other words, the processing module may query the corresponding field content from the number of stored files according to the query.

The video file may include a set of images or audio signals, and the tag data may include coordinates of the ROI in one of the set of images or a time period of the ROI in one of the audio signals. For example, assuming the ROI is located in the image of the video file, the coordinates may include X-axis coordinates and Y-axis coordinates of the ROI in the image, and the time period may be a time period of the ROI in the audio signal.

The inference data may include attribute data, the attribute data may be seen as a corresponding attribute assigned to the ROI, and the attribute data may include a classification result associated with the ROI, a cropped result associated with the ROI or a set of continuous coordinates of an outline associated with the ROI. The classification result may be a detection result of performing object detection, face detection and gender detection etc. on the image of the video file. The cropped result may be coordinates of a block cropped out according to the detection result. The set of continuous coordinates of the outline may be coordinates of the detection result, for example, coordinates of the outline constructing a person in the image.

In other embodiments, except for the above-mentioned first field and the second field, the fields of each of the stored files may further include a third field or/and a fourth field. The third field may store a source tag or a category tag of the video file, wherein the source tag indicates an electronic device generating the video file, and the category tag indicates the video file is an image or an audio signal. For example, said electronic device may be a camera device used to obtain the video file; the source tag may include serial number of the camera device and the geographic location of the camera device etc.; the category tag indicates whether the video file obtained by a camera device is an image or an audio signal.

The fourth field may store event data associated with the ROI, wherein the event data is generated according to the tag data and the inference data of at least one of the stored files by performing a set operation, and the set operation may be an intersection operation or a union operation. For example, the stored files may have one first field and a number of second fields, wherein the tag data of the first field indicates coordinates of one ROI in the image of the video file, and a number of pieces of inference data of the second fields indicate the object detection result (the classification result) performed in the ROI respectively. The set operation may include calculating the detection results indicating the number of human is detected in the pieces of inference data, and the event data may be generated according to detection results indicating the number of human is detected reaching a preset number. In other words, when the detection results indicating the number of human is detected reaches the preset number, the event data may indicate a crowd gathering situation occurs in the ROI. Moreover, when the stored file further has additional fields storing pieces of inference data associated with a person's posture, the event data generated according to the tag data and the inference data by performing the set operation may indicate behaviors of the people categorized as “crowd gathering” in the ROI, such as chatting or fighting.

In particular, the number of each of the first field, the second field, the third field and the fourth field described above in one stored file may be more than one. In an embodiment, the stored file includes a number of first fields and a number of second fields, and each of the second fields has a corresponding relationship with one of the first fields. That is, one first field may correspond to a number of second fields or does not correspond to any one of the second fields. Moreover, a number of second fields among all the second fields of one stored file may be generated based on a same first field. Therefore, there is also a situation where the first field does not correspond to any one of the second fields. For example, the tag data stored in each first field may be coordinates of each ROI in the video file, and the inference data stored in each second field may be detection results of face detection performed on each ROI. Therefore, when one or more human faces exist in the ROI indicated by the coordinates of the first field, one or more second fields correspond to this first field; and when there is no human face exists in the ROI indicated by the coordinates of the first field, none of the second fields corresponds to this first field.

Through the above-described data structure, data formats of analysis data outputted by each artificial intelligence analysis node (including inference engine node or other logic nodes) may be unified, such that different types of analysis data may be transmitted between artificial intelligence analysis nodes using different algorithms. Therefore, the overall analysis complexity and analysis time may be efficiently reduced, and thereby facilitating the integration and development of various analysis methods. It should be noted that, the number of fields shown in FIG. 1 is merely an example, the present disclosure does not limit field number in one stored file.

The present disclosure provides an artificial intelligence inference system which can use the data structure according to one or more embodiments described above to analyze input data. The artificial intelligence inference system of one or more embodiments of the present disclosure may have a search engine for the inference engine node or the logic node of the processing module to search for required data, and is adapted to a situation where multiple inference engines are connected in series as well as a situation where inference engine node and logic node are connected in series, wherein the logic node may be a node for performing logic operation or algorithm. The logic node may perform the set operation according to the tag data and the inference data to determine whether a specific event occurs.

Please refer to FIG. 2, wherein FIG. 2 is a block diagram illustrating an artificial intelligence inference system according to an embodiment of the present disclosure. As shown in FIG. 2, the artificial intelligence inference system 1 includes a storage module 11 and a processing module 12, wherein the storage module 11 is electrically connected to the processing module 12 or is in communication connection with the processing module 12. The storage module 11 may include, but not limited to, one or more of a flash memory, a hard disk drive (HDD), a solid state drive (SSD), a dynamic random access memory (DRAM) or a static random access memory (SRAM). The processing module 12 may include, but not limited to, a single processor and an integration of a number of microprocessor, such as a central processing unit (CPU), a graphics processing unit (GPU) etc. The storage module 11 and the processing module 12 may be commonly disposed at a user end, or the storage module 11 and the processing module 12 may be disposed at a cloud end and a user end respectively. A number of processors in the processing module 12 may be composed of processor of a user device and processor of a could server that are in communication connection with each other. That is, the operation of the artificial intelligence inference system 1 may be partially performed by the processor of the user device and partially performed by the processor of the cloud server.

The storage module 11 is configured to store the data structure described in said one or more embodiments. The processing module 12 receives the input data and the query. The processing module 12 searches the data structure according to the query to obtain the field content of at least one of the fields of at least one of the stored files, and performs analysis according to the input data and the field content to generate analysis data. To put it simply, take FIG. 1 as an example, the processing module 12 searches in the first field 101 and/or the second field 102 of the stored file 100 according to the query to obtain the field contents of the first field 101 and/or the second field 102, and performs analysis on the field contents and the input data to generate the analysis data. In an implementation, the storage module 11 includes a number of memories or hard disks described above, and may store the data structure described in said one or more embodiments. The processing module 12 may search the data structure according to the query to obtain the field content matching the query.

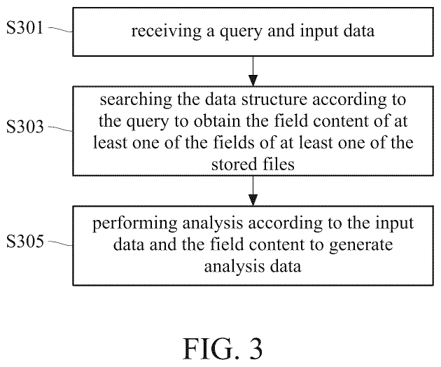

To further explain the application of the data structure described above, please refer to FIG. 2 and FIG. 3, wherein FIG. 3 is a flow chart illustrating an artificial intelligence inference method according to an embodiment of the present disclosure. As shown in FIG. 3 3, the artificial intelligence inference method illustrated according to an embodiment of the present disclosure includes: step S301: receiving a query and input data; step S303: searching the data structure according to the query to obtain the field content of at least one of the fields of at least one of the stored files; and step S305: performing analysis according to the input data and the field content to generate analysis data.

In step S301, the processing module 12 may receive the query from a user interface (for example, a keyboard, a mouse, a touch screen etc.), wherein the query may include one or more designated contents to designate obtaining data from the current inference engine or the logic node. In addition, the input data described in step S301 may be the video file received from the camera device, the coordinates of the ROI inferred by the previous inference engine, a part of the video file corresponding to the location of the ROI inferred by the previous inference engine, the time period corresponding to the audio signal of the ROI inferred by the previous inference engine, or other inference data generated through inference etc. In step S303, the processing module 12 searches and obtains data of the designated content corresponding to the query from the data structure to obtain the tag data, the inference data and/or the event data of at least one field of at least one stored file. Then, in step S305, the processing module 12 may perform analysis on the field content and the input data to generate the analysis data.

In an implementation, the designated content includes a ROI selection condition, wherein the ROI selection condition may include one or more of the following condition: for the tag data and the inference data can be matched to the identification code of the current inference engine, the inference data being designated attribute data, matching event data with results of performing the set operation on a number of ROIs, stage of intersection between a number of ROIs reaching a preset stage, the number of the ROIs reaching a preset number, stage of confidence corresponding to the ROI reaching a preset confidence stage, an area of a ROI or an area circled by an outline in a ROI reaching a preset area, a ROI locating at a specific location in an image of a video file (for example, locating at top-left corner, center or a range circled by a specific set of coordinates of the image) and the audio signal of the ROI belongs to a specific time period, etc.

In another implementation, in step S303, when the designated content includes a designated serial number associated with the camera device, the processing module 12 may search the data structure according to the designated source to obtain the field content (the tag data) corresponding to the designated serial number; then, in step S305, the processing module 12 may perform analysis on the video file (the input data) obtained by the camera device with the designated serial number, and use detection result as the analysis data, wherein said analysis is, for example, object detection, human face detection and gender detection. In yet another embodiment, in step S303, when the designated content includes designated time, the processing module 12 may search the data structure according to the designated time to obtain the field content (the tag data) corresponding to the designated time; then, in step S305, the processing module 12 may perform analysis on the video file (the input data) within the designated time, and use detection result as the analysis data, wherein said analysis is, for example, object detection, human face detection and gender detection. In other implementations, the designated content of the query may include two or all three of the ROI selection condition, the designated source and the designated time at the same time.

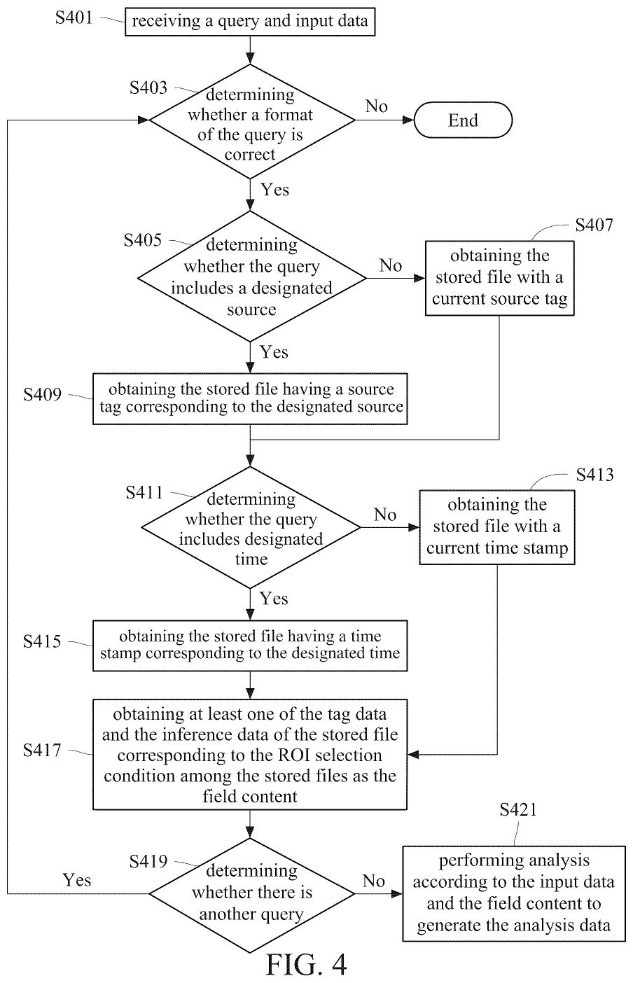

Please refer to FIG. 2 as well as FIG. 4, wherein FIG. 4 is a flow chart illustrating an artificial intelligence inference method according to another embodiment of the present disclosure. As shown in FIG. 4, the artificial intelligence inference method illustrated according to another embodiment of the present disclosure may include: step S401: receiving a query and input data; step S403: determining whether a format of the query is correct; when the result of step S403 is “yes”, performing step S405: determining whether the query includes a designated source; if the result of step S405 is “no”, performing step S407: obtaining the stored file with a current source tag; if the result of step S405 is “yes”, performing step S409: obtaining the stored file having a source tag corresponding to the designated source; step S411: determining whether the query includes designated time; if the result of step S411 is “no”, performing step S413: obtaining the stored file with a current time stamp; if the result of step S411 is “yes”, performing step S415: obtaining the stored file having a time stamp corresponding to the designated time; step S417: obtaining at least one of the tag data and the inference data of the stored file corresponding to the ROI selection condition among the stored files as the field content; step S419: determining whether there is another query; and when the result of step S419 is “no”, performing step S421: performing analysis according to the input data and the field content to generate the analysis data. It should be noted that, steps S403, S407, S413 and S419 shown in FIG. 4 are steps selectively performed, and step S401 may be the same as step S301 shown in FIG. 3, and therefore, the description of step S401 is not repeated herein.

In step S403, the processing module 12 may determine whether the format of the query is correct by determining whether the query contains invalid character or invalid designated content etc. When the format of the query is correct, the processing module 12 may perform step S405 to determine whether to select a certain data flow from data flows by determining whether the query includes the designated source. If the query does not include the designated source, it means the processing module 12 does not need to select the data flow, and the processing module 12 may perform step S407 to obtain the stored file with the current source tag, wherein the current source tag represents the data source is the previous inference engine or the logic node; if the query includes the designated source, it means the processing module 12 needs to select the data flow, and the processing module 12 may perform step S409 to obtain the selected stored file with the source tag. For example, the designated source may be a designated serial number of the camera device, the processing module 12 may select a serial number corresponding to the designated serial number from multiple serial numbers corresponding to the video files respectively to obtain one or more stored files of the selected one or more serial numbers.

After obtaining the stored files through step S407 or step S409, in step S411, the processing module 12 may determine whether the selection of the stored file with a specific time stamp needs to be performed by determining whether the query includes the designated time. If the query does not include the designated time, the processing module 12 may perform step S413 to obtain the stored file with the current time stamp, wherein the current time stamp is a time stamp of the stored file generated by the previous inference engine or the logic node; if the query includes the designated time, the processing module 12 may perform step S417 to obtain the stored file with the selected time stamp. The time stamp may include a specific date, a coordinated universal time (UTC), a system clock and a predetermined period before the current moment, wherein the predetermined period is, for example, 5 minutes. In other words, from step S405 to step S415, the processing module 12 may first selectively select multiple stored files according to the designated source, then selectively select one or more stored files from said multiple stored files according to the designated time.

In step S417, the processing module 12 may perform selection on the tag data and the inference data of the selected stored file according to the ROI selection condition to obtain the field data, wherein the ROI selection condition described herein is the same as the one described above, and the description of the ROI selection condition is not repeated herein. When the tag data and/or the inference data of the stored file matches the ROI selection condition, the processing module 12 may use the tag data and/or the inference data of this stored file as the field content for the inference engine or the logic node to perform analysis. Then, if there is another query, the processing module 12 may perform step S403 again; and if there is no unprocessed query left, the processing module 12 may perform step S421 to perform analysis according to the input data and the field content, wherein examples of the processing module 12 performing analysis on the input data and the field content are described below.

Through the embodiment of FIG. 4, in a situation where a number of inference engines are connected in series, each of the inference engine may obtain data required for performing analysis, and may not need to confirm again whether the obtained data is the data required for performing the analysis. Therefore, the efficiency of the inference engine obtaining analysis data to be processed may be improved.

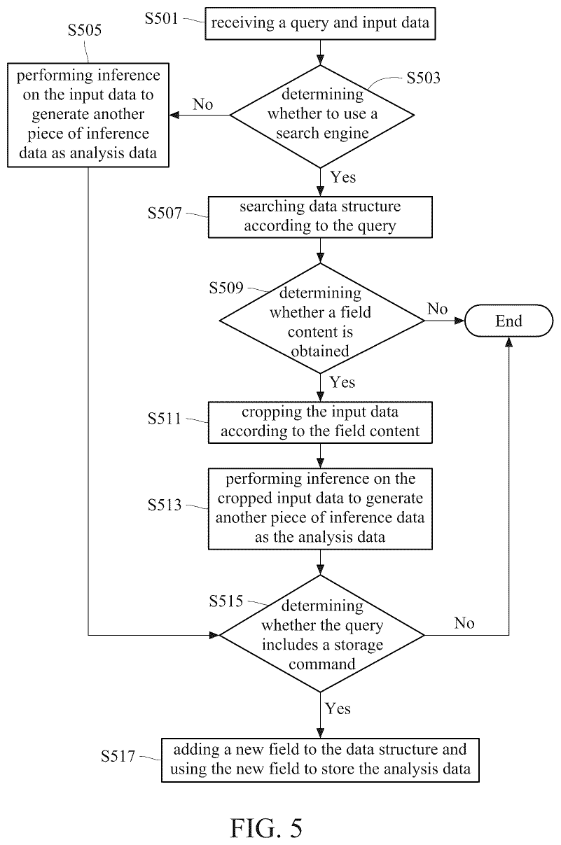

Please refer to FIG. 2 and FIG. 5, wherein FIG. 5 is a flow chart illustrating an artificial intelligence inference method according to yet another embodiment of the present disclosure. As shown in FIG. 5, the artificial intelligence inference method according to yet another embodiment of the present disclosure may include: step S501: receiving a query and input data; step S503: determining whether to use a search engine; if the result of step S503 is “no”, performing step S505: performing inference on the input data to generate another piece of inference data as analysis data; if the result of step S503 is “yes”, performing step S507: searching data structure according to the query; step S509: determining whether a field content is obtained; when the result of step S509 is “yes”, performing step S511: cropping the input data according to the field content; step S513: performing inference on the cropped input data to generate another piece of inference data as the analysis data; step S515: determining whether the query includes a storage command; and when the result of step S505 is “yes”, performing step S517: adding a new field to the data structure and using the new field to store the analysis data. It should be noted that, step S515 may be performed directly after step S501, meaning step S515 may be performed right after obtaining the query (step S501), the present disclosure does not limit the moment of performing step S515. In addition, steps S503, S505 and S509 may be steps selectively performed, and step S501 may be the same as step S301 shown in FIG. 3, and therefore, the description of step S501 is not repeated herein.

In step S503, the processing module 12 may determine whether the query includes any designated content to determine whether to use the search engine to obtain the field content. If, according to the query, the processing module 12 determines not to use the search engine, the processing module 12 may perform step S505 to perform inference on the input data coming from the previous inference engine or the logic node to generate the analysis data; if, according to the query, the processing module 12 determines to use the search engine, the processing module 12 may perform steps S507 and S509 to search the data structure according to the query and determine whether the field content is obtained. Step S507 may be implemented by, for example, steps S403 to S419 as shown in FIG. 4. That is, using the search engine according to the query to search the data structure may be implemented by steps S403 to S419. If the field content is not obtained, it may mean that the data structure does not store the designated content of the query, then the method is ended; and if the field content is obtained, the processing module 12 may perform step S511 to crop out a block in the ROI (the input data) according to the field content needed for performing analysis. For example, when the input data is the image of the ROI inferred by the previous inference engine, the processing module 12 may crop the image of the ROI according to the field content, for example, the processing module 12 may crop the image of the ROI according to a set of continuous coordinates of the outline to obtain the image of the outline. When the input data is the audio signal or a times series of the ROI, the processing module 12 may crop out the time period of the ROI according to the field content, for example, cropping out the time period where said outline is presented in the image.

Then, in step S513, the processing module 12 may perform inference on the cropped input data to generate another piece of inference data. In step S515, the processing module 12 may determine whether the query received in step S501 includes the storage command, wherein the storage command is a command instructing storing the analysis data. When the query includes the storage command, the processing module 12 may perform step S517 to add the new field into the stored file where the field content determined in step S509 belongs to, and use the new field to store the analysis data which is the another piece of inference data. Accordingly, in a situation where a number of inference engines are connected in series, each inference engine may directly obtain data required for performing analysis. In other words, each inference engine may perform inference independently on the input data, and when the inference approach needs to be changed (using different inference engine), the inference approach may be instantly changed by changing the query or replacing the inference engine before the input data entering the inference engine.

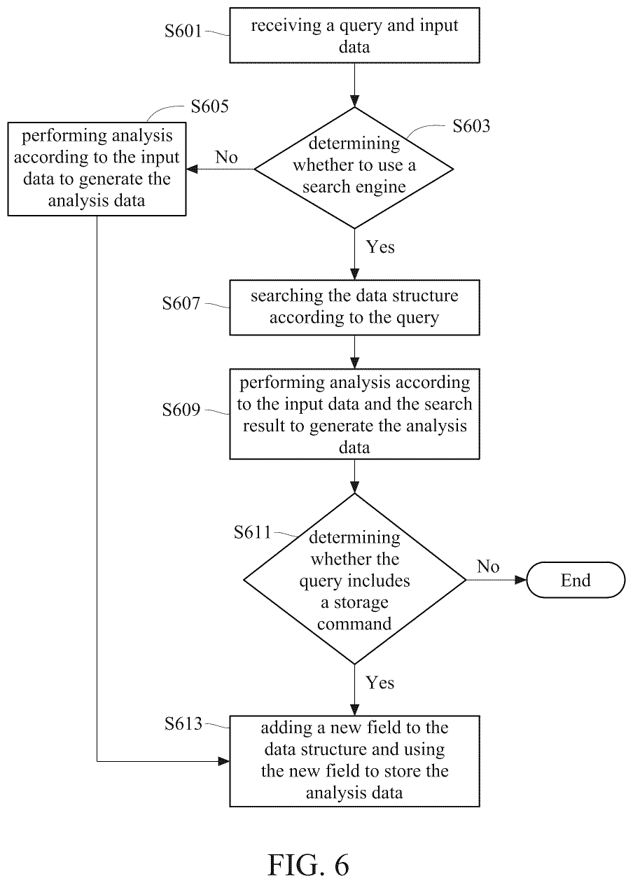

Please refer to FIG. 2 and FIG. 6, wherein FIG. 6 is a flow chart illustrating an artificial intelligence inference method according to still another embodiment of the present disclosure. The differences between FIG. 5 and FIG. 6 lie in that, steps shown in FIG. 6 may be used to logic node that is not an inference engine. As shown in FIG. 6, the artificial intelligence inference method according to still another embodiment of the present disclosure may include: step S601: receiving a query and input data; step S603: determining whether to use a search engine; if the result of step S603 is “no”, performing step S605: performing analysis according to the input data to generate the analysis data; if the result of step S603 determine is “yes”, performing step S607: searching the data structure according to the query; step S609: performing analysis according to the input data and the search result to generate the analysis data; step S611: determining whether the query includes a storage command; and if the result of step S611 is “yes”, performing step S613: adding a new field to the data structure and using the new field to store the analysis data. It should be noted that, step S611 may be performed directly after step S601, meaning step S611 may be performed right after obtaining the query (step S601), the present disclosure does not limit the moment of performing step S611. In addition, steps S603 and S605 may be steps selectively performed, step S601 may be the same as step S301 shown in FIG. 3, and steps S603, S607, S611 and S613 may be the same as steps S503, S507, S515 and S517 shown in FIG. 5, and therefore, the description of steps S601, S603, S607, S611 and S613 are not repeated herein.

In step S605, the processing module 12 may directly perform analysis according to the input data outputted by the previous inference engine or the logic node. Specifically, the input data may be the image of the ROI or the image of the video file, and the processing module 12 may perform analysis such as object detection, face detection and posture detection etc. on the input data, and perform the intersection operation or logic operation on these detection results to generate the event data as the analysis data. On the other hand, in step S609, the processing module 12 may also perform analysis such as object detection, face detection and posture detection etc. on the input data. The difference between step S609 and step S605 is that, in step S609, the processing module 12 performs analysis according to the input data and search result, wherein the search result may be the tag data or the inference data of the stored file. For example, in step S609, the input data may be the image of the ROI inferred by the previous inference engine, and the search result may be coordinates of a block containing a human face in the ROI, and the analysis performed by the processing module 12 may be a gender analysis. That is, the processing module 12 may crop the ROI (the input data) inferred by the previous inference engine according to the coordinates (the search result) of a block with a human face in it, perform the gender analysis on the block that is cropped out, and use the result of the gender analysis as the analysis data. After performing the analysis data, the processing module 12 may then perform step S613 accordingly.

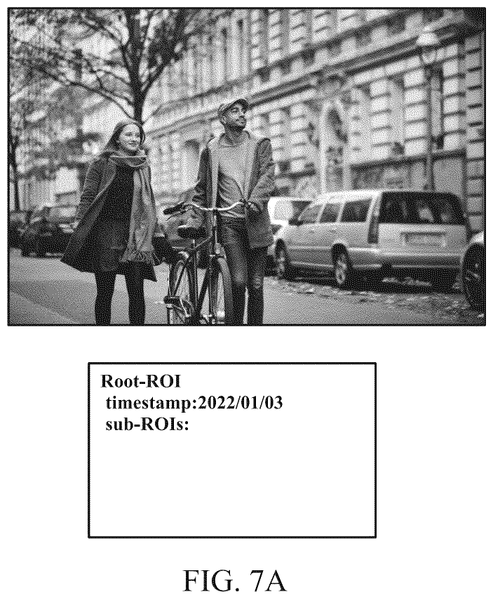

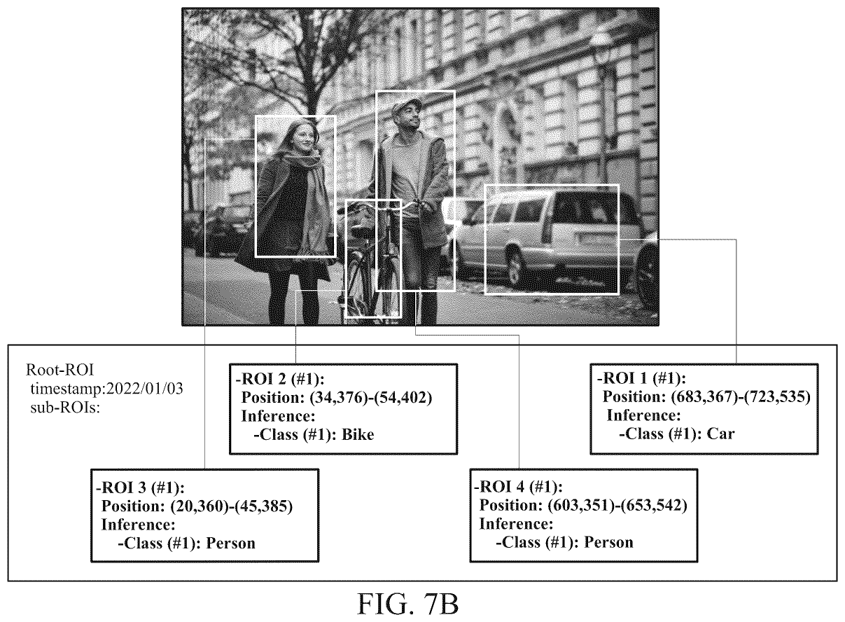

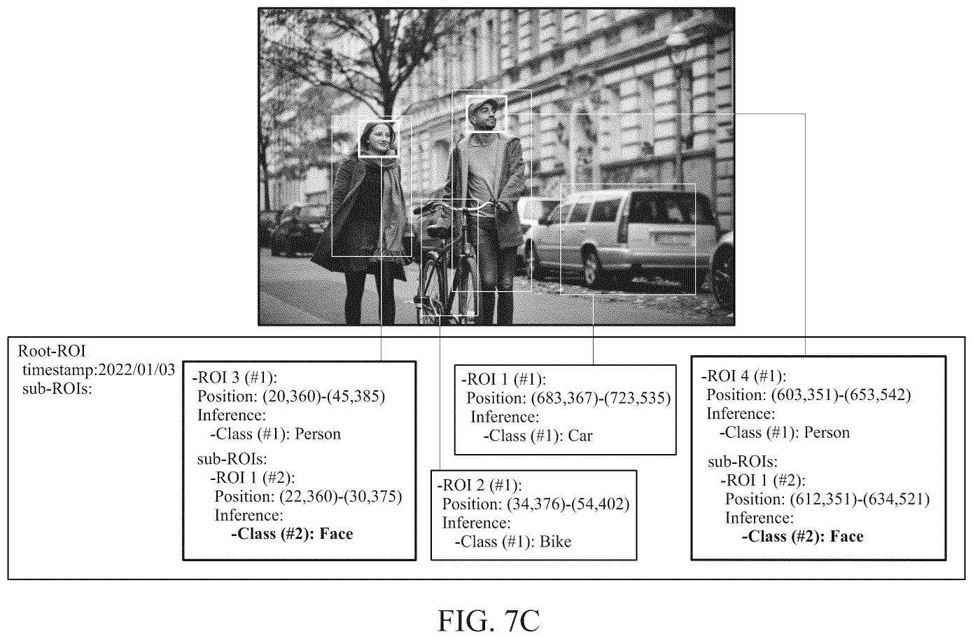

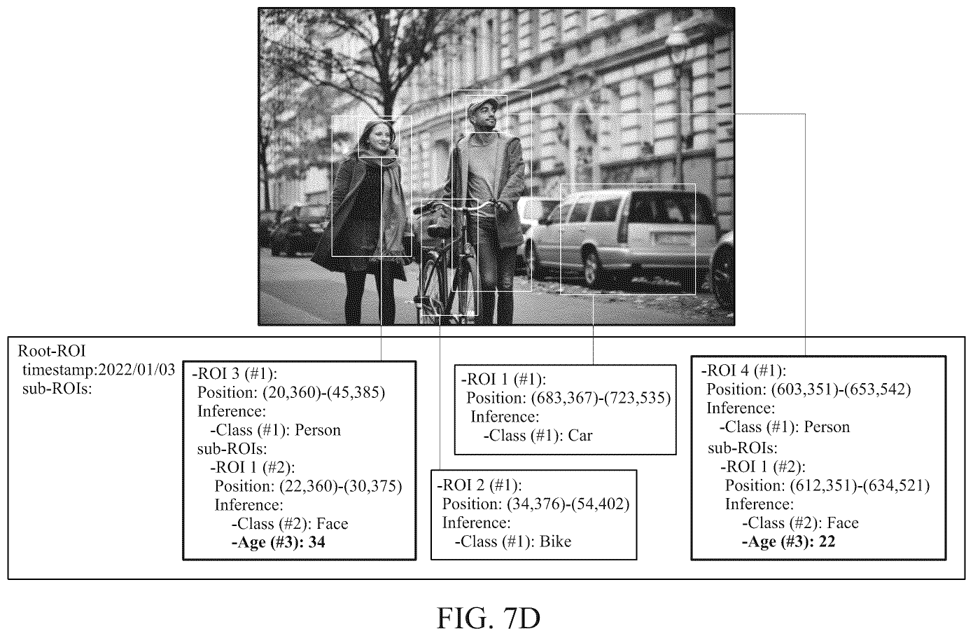

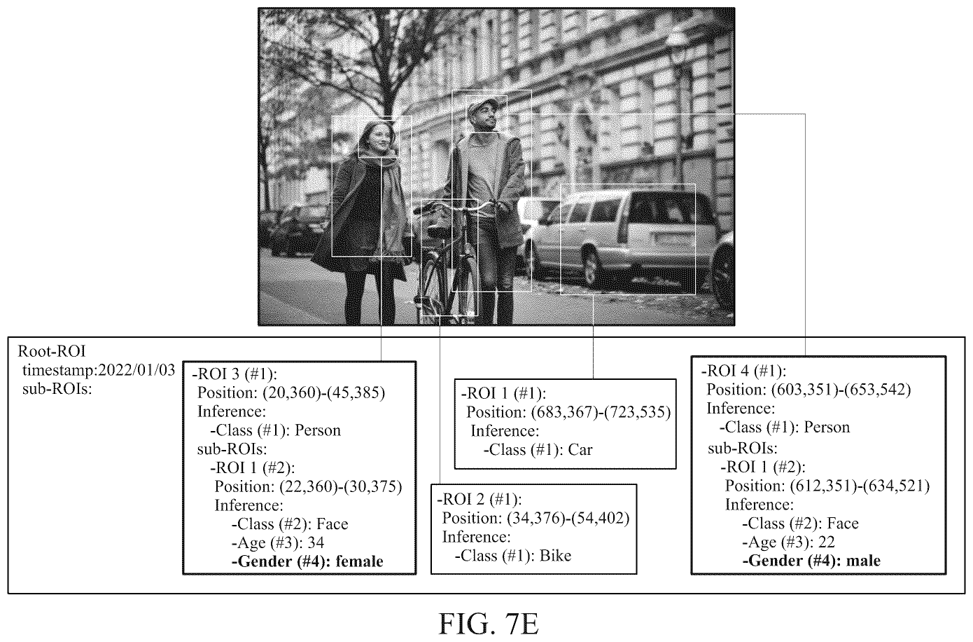

Please refer to FIG. 7A to FIG. 7E, wherein FIG. 7A to FIG. 7E are schematic diagrams showing changes of a stored file of a data structure during the process of the artificial intelligence inference method of an embodiment of the present disclosure. FIG. 7A to FIG. 7E illustrate schematic diagrams of one stored file of the process from obtaining the video file to performing inference on the ROI at each stage to generate a data structure, wherein bold words and thick lines represent data generated at that stage of inference. It should be noted that, in the example of FIG. 7A to FIG. 7E, one root region of interest (root-ROI) may include one or more sub region of interests (sub-ROIs), and each sub-ROI may include more detailed ROIs, and each sub-ROI and more detailed ROIs have the corresponding tag data and inference data respectively. For example, a number of sub-ROIs and their more detailed ROIs may have the same identification code (first identification code), and the ROIs using the same inference engine or the logic node to analyze data may have the same identification code (second identification code).

In FIG. 7A, the processing module 12 obtains the video file, uses one of the set of images of the video file as the root-ROI, and records the time stamp of the root-ROI into the stored file. In FIG. 7B, the processing module 12 performs object detection on the image using the first inference engine to obtain a number of sets of coordinates of a number of objects in the image and the classification results of the objects. The processing module 12 uses the sets of coordinates as the tag data and store the sets of coordinates into the respective first fields, uses the classification results as the inference data and store the classification results into the respective second fields, and adds the identification codes for the classification results to have the second identification code (marked as #1 in the drawings).

As shown in FIG. 7B, the tag data stored by the first field includes the coordinates of each ROI (ROI 1 to ROI 4), the inference data stored by the second field includes the classification result of object detection, such as car, person and bicycle. In FIG. 7C, the processing module 12 uses the second inference engine to perform face detection on ROIs (ROI 3 and ROI 4) with the classification result of person to further determine whether there are human faces in the ROIs (ROI 3 and ROI 4).

As shown in FIG. 7C, the processing module 12 may use the blocks with human faces as sub-ROIs, use another first field to store the maximum coordinates and minimum coordinates of the sub-ROIs, and use another second field to store the classification result (marked as #2 in the drawings) of face detection.

In FIG. 7D, the processing module 12 uses the third inference engine to perform age analysis on sub-ROIs with the classification result being a human face, and uses yet another second field to store the result of age analysis (marked as #3 in the drawings). In FIG. 7E, the processing module 12 uses the fourth inference engine to perform gender analysis on sub-ROIs with the classification result being a human face, and uses still another second field to store the result of gender analysis (marked as #4 in the drawings).

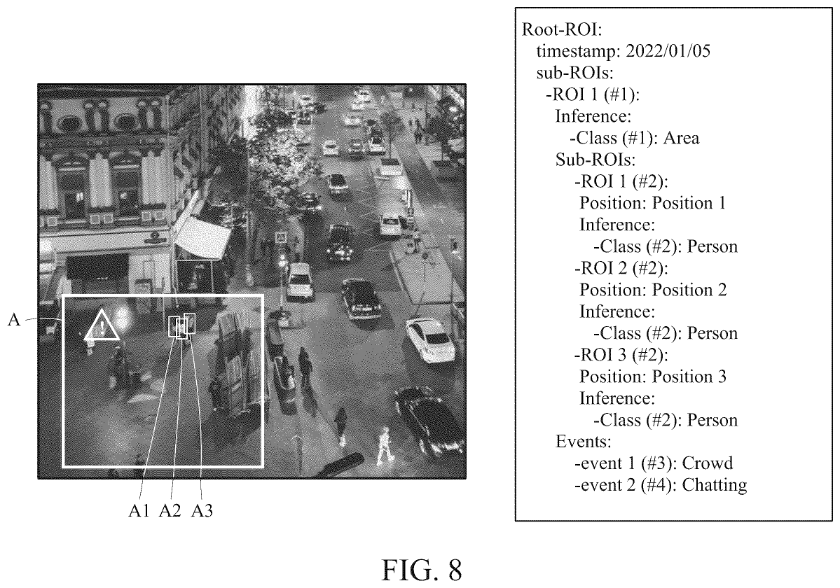

Please refer to FIG. 8, wherein FIG. 8 is a schematic diagram illustrating a stored file of a data structure after performing the artificial intelligence inference method of an embodiment of the present disclosure. FIG. 8 illustrates an example of the logic node determining whether a specific event occurs based on inference results of the inference engines. Similarly, in the example of FIG. 8, the processing module 12 may first use the image of the video file as the root-ROI and records the time stamp of the root-ROI into the stored file. Then, the processing module 12 uses the first inference engine to perform classification on the root-ROI to obtain the classification results of a main region A, and uses the classification results as the inference data to store the classification results into the respective second fields, wherein the main region A may be a region on the sidewalk. In another implementation, the main region A may also be a user-defined region. The processing module 12 uses the second inference engine to perform human detection on the main region A to obtain a number of detected regions A1 to A3, stores positions of the detected regions A1 to A3 into the first fields, uses results of human detection of the detected regions A1 to A3 as the classification results, and stores the classification results into other second fields. The processing module 12 uses the first logic node to analyze if a crowd gathering event occurs, and stores the crowd gathering event into another field of the stored file when determining the crowd gathering event occurs, wherein the first logic node may determine the crowd gathering event occurs when a number of detected regions in the main region A reaches a default number. The processing module 12 may further use the second logic node to analyze whether a chatting event occurs, when determining the crowd gathering event occurs, and store the chatting event into yet another field of the stored file when determining the chatting event occurs, wherein the second logic node may determine the chatting event occurs when the crowd gathering event occurs and the posture of each person in the detected regions A1 to A3 matches a preset posture (for example, every person in the detected regions A1 to A3 are facing each other).

In another implementation, a ROI may be a no-entry region, and the processing module 12 may use the inference engine to perform inference on the ROI to detect if anyone enters the no-entry region. The processing module 12 may store an entry event into the corresponding field of the stored file with the logic node when the inference result indicates someone enters the no-entry region.

By generating a data structure with hierarchy through the implementations described along with FIG. 7A to FIG. 7E and FIG. 8, the inference engine may directly search for the required tag dataset/or inference data from the data structure, which lowers the time the system spent on performing data analysis. The examples shown in FIG. 7A to FIG. 7E and FIG. 8 may be displayed by a display device.

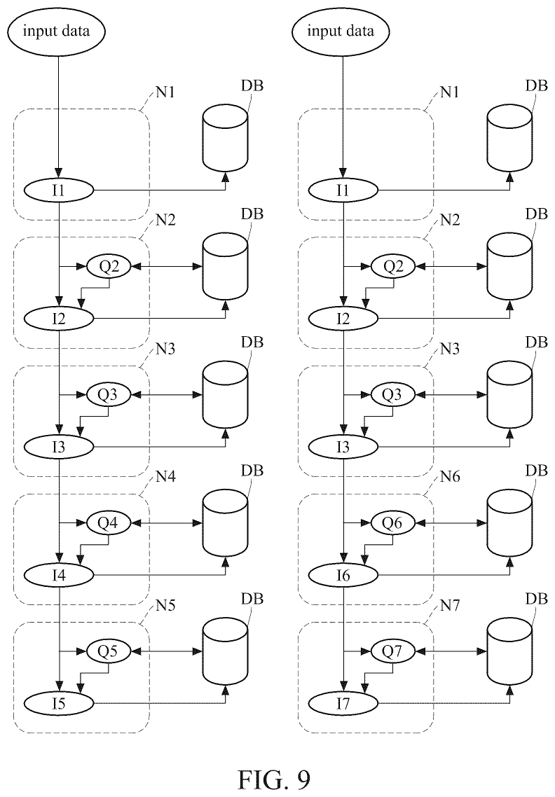

Please refer to FIG. 9, wherein FIG. 9 illustrates an example of applying the artificial intelligence inference method and system on store entrance event analysis and advertising projection system. The left side of FIG. 9 illustrates applying the artificial intelligence inference method and system to store entrance event analysis (referred to as the “first situation” herein), and the right side of FIG. 9 illustrates applying the artificial intelligence inference method and system to advertising projection system (referred to as the “second situation” herein). It should be noted that, the data base DB described below may be built in the storage module 11, and all the inference engines and the logic nodes can access the same data base DB, but in other embodiments, the inference engines and the logic nodes may also access multiple different data bases.

In the first situation, a camera device may be disposed at the store entrance to capture images of the store entrance, for the processing module 12 to use the image as the input data to perform inference to obtain the inference data. First, the processing module 12 uses a first inference engine I1 of a first node N1 to read pre-stored coordinates of the store entrance, circles a ROI according to the pre-stored coordinates, and uses a number of sets of coordinates of the circled ROIs as the data of the first stage and store the sets of coordinates into the data base DB. Then, the processing module 12 uses a second query node Q2 to read the image of the ROI from the data base DB, uses the image of the ROI as the input data, and uses a second inference engine I2 of a second node N2 to perform human detection on the image of the ROI (the input data), uses the detection result as the input data of the next stage of the ROI, and stores the detection result into the data base DB, wherein the second inference engine I2 preferably only stores detection results indicating a pedestrian is in the ROI into the data base DB. The processing module 12 uses a third query node Q3 to read the detection result from the data base DB, uses a third inference engine I3 of a third node N3 to perform posture analysis on the pedestrian, uses the result of posture analysis as data of the next stage of the detection result and stores the result of posture analysis into the data base DB.

Then, the processing module 12 uses a fourth query node Q4 to read the result of posture analysis from the data base DB, uses an event analysis logic I4 of a fourth node N4 to determine if a specific event occurs in the ROI according to the result of posture analysis, the specific event is, for example, the pedestrian is smoking in the ROI, the pedestrian is using a mobile device or the pedestrians are fighting etc. The event analysis logic I4 uses event data of the specific event as the data of the stage following the result of posture analysis, and stores the event data into the data base DB. The processing module 12 uses a fifth query node Q5 to search the event data corresponding to a certain period from the data base DB, and uses an alert logic I5 of a fifth node N5 to determine if an alert should be outputted according to the event data when the search result exists (that is, the event indicated by the event data did occur in the certain period), uses the result of determination and/or notification contents as the data of the stage following event analysis and stores the result of determination and/or notification contents into the data base DB. For example, when the fifth query node Q5 reads from the data base DB that a fighting event occurred at a certain time period, the alert logic I5 may output an alert.

In the second situation, the implementations of the first node N1 to the third node N3 are the same as that of the example of store entrance event analysis, and the description of the first node N1 to the third node N3 are not repeated herein. After storing the result of posture analysis into the data base DB, the processing module 12 uses a sixth query node Q6 to read the result of posture analysis from the data base DB, uses a sixth inference engine I6 of the sixth node N6 to further perform human face analysis on the block performed with posture analysis, uses the result of human face analysis as the data of the stage following the result of posture analysis and stores the result of human face analysis into the data base DB, wherein the result of human face analysis may indicate gender and age of a pedestrian. The processing module 12 uses a seventh query node Q7 to read the result of human face analysis from the data base DB, uses an advertising logic I7 of the seventh node N7 to generate advertisement according to the result of human face analysis, uses the advertisement as the data of the stage following the result of human face analysis and stores the advertisement into the data base DB.

For example, the result of posture analysis may include the swing range of hands and legs when the pedestrian walks, the result of human face analysis may include the gender of the pedestrian. Therefore, assuming the result of posture analysis is the swing range of hands and legs when the pedestrian walks being smaller than a preset swing range, and the result of human face analysis indicates the pedestrian being a woman, then in the seventh node N7, the processing module 12 may determine the pedestrian is a woman according to the result of posture analysis and the result of human face analysis, and thereby generating advertisement of cosmetics products or skincare products.

It can be seen from the implementation of FIG. 9 that, the application of the first situation may be easily changed to the application of the second situation by replacing the last two nodes of the first situation into the nodes of the human face analysis inference engine I6 and the advertising logic I7, thereby realizing modularization of deep learning applications.

A part of the steps or all of the steps of the method described in the above embodiments may be implemented by a computer program, such as random combination of an application, a driving program, an operating system etc. A person having ordinary skill in the art can write the methods of the above embodiments of the present disclosure into computer code, which will not be described for the sake of brevity. The computer program or/and the data structure implemented according to the method of the above-mentioned embodiments of the present disclosure may be stored in an appropriate non-transitory computer readable storage medium, such as DVD, CD-ROM, U disk, hard disk, or may also be disposed in an internet server that is accessible through internet (for example, Internet or other appropriate medium). In an embodiment, the non-transitory computer readable storage medium stores the data structure and the computer program of the embodiments described above, said computer program reads the stored file in the data structure when executed by a data processing device, and outputs a field content of at least one of the fields of at least one of the stored files according to a query.

In view of the above description, the data structure according to one or more embodiments of the present disclosure may store analysis data outputted by each artificial intelligence analysis node with unified data format, for different types of analysis data may be transmitted between artificial intelligence analysis nodes using different algorithms. Therefore, the overall analysis complexity and analysis time may be efficiently reduced, and thereby facilitating the integration and development of various analysis methods. In addition, the artificial intelligence inference system and method according to one or more embodiments of the present disclosure may be applied to a situation where a number of inference engines are connected in series as well as a situation where the inference engine and the logic node are connected in series, such that each of the inference engine may obtain data required for performing analysis, and may not need to confirm again whether the obtained data is the data required for performing the analysis. Therefore, the efficiency of the inference engine obtaining analysis data to be processed may be improved. Moreover, the artificial intelligence inference system and method according to one or more embodiments of the present disclosure may apply the inference engines to different application situations easily by replacing part of the inference engines that are connected in series, thereby realizing modularization of deep learning applications.

What is claimed is:

1. A non-transitory computer readable storage medium storing a data structure and a computer program, with the data structure comprising:
a plurality of stored files each of which comprises a plurality of fields comprising:
at least one first field storing tag data of a region of interest of a video file; and
at least one second field storing inference data associated with the region of interest;
wherein the computer program reads the stored files and outputs a field content of at least one of the fields of at least one of the stored files according to a query when executed by a data processing device.

2. The non-transitory computer readable storage medium according to claim 1, wherein the video file comprises a set of images or audio signals, and the tag data comprises a set of coordinates of the region of interest in one of the set of images or a time period of the region of interest in one of the audio signals.

3. The non-transitory computer readable storage medium according to claim 1, wherein the inference data comprises attribute data, and the attribute data comprises: a classification result associated with the region of interest, a cropped result associated with the region of interest, or a set of continuous coordinates of an outline associated with the region of interest.

4. The non-transitory computer readable storage medium according to claim 1, wherein the fields further comprises:
a third field storing a source tag or a category tag of the video file, wherein the source tag indicates an electronic device generating the video file, and the category tag indicates that the video file is either image or audio.

5. The non-transitory computer readable storage medium according to claim 1, wherein the fields further comprises:
a fourth field storing event data associated with the region of interest, wherein the event data is generated by performing a set operation according to the tag data and the inference data of at least one of the stored files.

6. The non-transitory computer readable storage medium according to claim 1, wherein the at least one first field is a plurality of first fields, the at least one second field is a plurality of second fields, and each of the second fields has a corresponding relationship with one of the first fields.

7. The non-transitory computer readable storage medium according to claim 1, wherein the stored files each have a time stamp.

8. An artificial intelligence inference system, comprising:
a storage module configured to store a data structure, wherein the data structure comprises:
a plurality of stored files each of which comprises a plurality of fields comprising:
at least one first field storing tag data of a region of interest of a video file; and
at least one second field storing inference data associated with the region of interest; and
a processing module connected to the storage module, and configured to receive a query and input data, search the data structure according to the query to obtain a field content of at least one of the fields of at least one of the stored files, and perform analysis according to the input data and the field content to generate analysis data.

9. The artificial intelligence inference system according to claim 8, wherein when the query comprises a region of interest selection condition, the processing module obtains at least one of the tag data and the inference data of the stored file corresponding to the region of interest selection condition among the stored files as the field content.

10. The artificial intelligence inference system according to claim 8, wherein each of the stored files has a timestamp, and when the query comprises a designated time, the processing module reads the stored file with the time stamp corresponding to the designated time among the stored files.

11. The artificial intelligence inference system according to claim 8, wherein the fields of each of the stored files further comprise a third field, with the third field storing a source tag of the video file, wherein the source tag indicates an electronic device generating the video file, and when the query comprises a designated source, the processing module reads the stored file with the source tag corresponding to the designated source among the stored files.

12. The artificial intelligence inference system according to claim 8, wherein the processing module performing analysis according to the input data and the field content to generate the analysis data comprises:
cropping the input data according to the field content; and
performing inference on the cropped input data to generate another inference data as the analysis data.

13. The artificial intelligence inference system according to claim 8, wherein when the query comprises a storage command, the processing module adds a new field to the data structure and uses the new field to store the analysis data.

14. The artificial intelligence inference system according to claim 8, wherein the processing module performing analysis according to the input data and the field content to generate the analysis data comprises: performing a set operation according the input data and the tag data and the inference data of at least one of the stored files to generate event data as the analysis data.

15. An artificial intelligence inference method, applicable to an artificial intelligence inference system, wherein the artificial intelligence inference system comprises a storage module and a processing module, with the storage module storing a data structure, the data structure comprises a plurality of stored files each of which comprises a plurality of fields comprising: at least one first field storing tag data of a region of interest of a video file; and at least one second field storing inference data associated with the region of interest, with the artificial intelligence inference method, performed by the processing module, comprising:
receiving a query and input data;
searching the data structure according to the query to obtain a field content of at least one of the fields of at least one of the stored files; and
performing analysis according to the input data and the field content to generate analysis data.

16. The artificial intelligence inference method according to claim 15, wherein the query comprises a region of interest selection condition, and searching the data structure according to the query to obtain the field content of at least one of the fields of at least one of the stored files comprises:
obtaining at least one of the tag data and the inference data of the stored file corresponding to the region of interest selection condition among the stored files as the field content.

17. The artificial intelligence inference method according to claim 15, wherein each of the stored files has a timestamp, and searching the data structure according to the query to obtain the field content of at least one of the fields of at least one of the stored files comprises:
determining whether the query comprises a designated time; and
reading the stored file with the time stamp corresponding to the designated time among the stored files when the query comprises the designated time.

18. The artificial intelligence inference method according to claim 15, wherein the fields of each of the stored files further comprise a third field, with the third field storing a source tag of the video file, wherein the source tag indicates an electronic device generating the video file, and searching the data structure according to the query to obtain the field content of at least one of the fields of at least one of the stored files comprises:
determining whether the query comprises a designated source; and
reading the stored file with the source tag corresponding to the designated source among the stored files when the query comprises the designated source.

19. The artificial intelligence inference method according to claim 15, wherein performing analysis according to the input data and the field content to generate the analysis data comprises:
cropping the input data according to the field content; and
performing inference on the cropped input data to generate another inference data as the analysis data.

20. The artificial intelligence inference method according to claim 15, wherein performing analysis according to the input data and the field content to generate the analysis data comprises:
determining whether the query comprises a storage command; and
adding a new field to the data structure and using the new field to store the analysis data when the query comprises the storage command.

21. The artificial intelligence inference method according to claim 15, wherein performing analysis according to the input data and the field content to generate the analysis data comprises:
performing a set operation according the input data and the tag data and the inference data of at least one of the stored files to generate event data as the analysis data.
